(19) United States
(12) Patent Application Publication
(10) Pub. No.: US 2026/0041128 A1
(43) Pub. Date: Feb. 12, 2026

(54) Batters Using Treated Legume Flours and Concentrates

(71) Applicant: CORN PRODUCTS DEVELOPMENT, INC., WESTCHESTER, IL (US)

(72) Inventors: Ying BIAN, Bridgewater, NJ (US); Joseph EISLEY, Bridgewater, NJ (US); Samuel HORMEL, Bridgewater, NJ (US); Ron PAGAOA, Bridgewater, NJ (US); Himanshu SHAH, Bridgewater, NJ (US)

(21) Appl. No.: 19/103,054

(22) PCT Filed: Jul. 25, 2023
(86) PCT No.: PCT/US2023/070920

§ 371 Date: Feb. 11, 2025

Related U.S. Application Data
(60) Provisional application No. 63/399,341, filed on Aug. 19, 2022.
(60) Provisional application No. 63/498,324, filed on Apr. 26, 2023.

(51) Int. Cl. A23L 11/00; A23J 3/14; A23L 13/50; A23P 20/10

(52) U.S. Cl. CPC A23L 11/05; A23J 3/14; A23L 13/57; A23P 20/10

(57) ABSTRACT

The technology disclosed in this specification pertains to a dry solids coating composition comprising blend of a legume flour and legume protein concentrate for use as a partial or complete replacement of wheat flour or non-legume starches or mixture thereof in batters and coatings for food compositions. In various embodiments the legume flour and legume protein concentrate are partially denatured to have a defined amount of starch damage or protein damage.

This specification discloses batters comprising legume flours and legume protein concentrates. More specifically the batters are fry batters that are made using less solids content than common wheat flour-based batters without sacrificing viscosity or coating pickup.

Fry batters used to coat foods for frying. Fry batters are commonly made from wheat flour and commonly have from 35% to 40% solids content (wt. %). Lower solids batters are less viscous and do not coat the underlying food well. This specification discloses batters that are useful as coatings for fried foods but that have relatively low solids content compared to wheat-based batters. The disclosed batters. although have lower solids content, have high viscosity. good coating pick-up, and are stable against water separation for at least three days at refrigerated temperatures.

The batters disclosed comprise a legume flour and a legume protein concentrate. In at least some embodiments one or more of the legume flour and legume protein concentrate are treated. In at least one embodiment a least a legume flour is a treated legume flour. In at least some other embodiments a batter comprises both a treated legume flour and a treated legume protein concentrate.

Legume flours are milled compositions obtained from a legume. Legume flours are obtained using known wet or dry milling processes. Legume flours contain starch, protein, fiber, and other constituent parts that are present in an unmilled legume. All parts of a legume flour are in essentially the same proportions as in the legume. Legume flours generally comprise about 20 to about 30% protein. In this specification. flour covers the term as used in the art. In at least some embodiments flour includes protein depleted flours. Methods for removing at least part of the protein from flour are known. For example. the alternate stream obtained from a process to make a legume protein concentrate is protein depleted: this side stream is flour for purposes of this specification. Other methods, such as wet milling and protein isolation processes are also known. The starch side stream from wet milling and protein isolation processes may contain protein: this side stream is flour for this specification. In embodiments legume flours in this specification comprise protein in an amount from 0.1% to about 30% wt.%, or from 0.5, or from about 1% or from about 5% or from about 10%, or from about 15%, or from about 20% to about 30%. In some preferred embodiments the legume flour has protein content in the range between 0.1% and 3%. In other preferred embodiments the legume flour has protein content from 5% to 15%. In some preferred embodiments the legume flour has from 20 to 30%.

Legume protein concentrates are milled compositions obtained from a legume and that have had at least some of the starch removed. So legume protein concentrates have higher protein concentration than legume flours. Legume protein concentrates as used in this specification have protein content from at least about 40%, or at least about 45%, or at least about 50%, or at least about 55% up to at most about 75%, or at most about 70%, or at most about 65%.

Treated legume protein flours and treated legume protein concentrates are legume flours and legume protein concentrates that have been treated to remove at least some flavors from the legume protein. Although various de-flavoring processes can be used, preferred de-flavoring methods use heat and moisture, for example as described in this specification in Examples 1 to 7. Variations on such methods are further described in U.S. Provisional Patent Application No. 63/235,191 and U.S. Provisional Patent Application No. 63/235,229, which are incorporated herein in their entirety.

The batters described in this specification are made by mixing a dry solids coating composition with water and blending the mixture until it is homogenous. A dry solids coating composition, as described in this specification, is a mixture of the solid ingredients that make up the batter. In any embodiment described in a dry solids coating composition comprises a legume flour in an amount from about 30% or from about 35% to about 70% wt.% of the composition, or from about 30% to 60%, or from about 30% to about 50%, or from about 30% to about 45%, or 40% to about 70%, or to about 60%, or to about 50%; and a legume protein concentrate from about 30% or from about 35% to about 70% wt.% of the composition, or from about 30% to 60%, or from about 30% to about 50%, or from about 30% to about 45%, or 40% to about 70%, or to about 60%, or to about 50% wherein the composition is comprised a total amount of legume flour and the legume protein concentrate of from about 30% or from about 35% to about 70% wt.% of the composition, or from about 30% to 60%, or from about 30% to about 50%. or from about 30% to about 45%, or 40% to about 70%, or to about 60%, or to about 50%.

In any embodiment a dry solids coating composition comprises one or more of a treated legume flour and treated legume protein concentrate. In any embodiment a dry solids coating composition comprises at least a treated legume flour. In any embodiment a dry solids coating composition comprises a treated legume flour and a treated legume protein concentrate.

The legume flour and legume protein concentrate may be described by various physical characteristics. In any embodiment of a dry solids coating composition described in this specification, a legume flour has a water holding capacity of at least about 1.4 (g/g), or at least about 2.0 or, at least about 2.15 or from about 2.15 to about 3.00 (g/g), or from about 2.15 to about 2.75, or to about 2.60, or to about 2.55, or to about 2.50, optionally wherein the legume flour is a treated legume flour.

The de-flavoring process damages starch in the flour or concentrate meaning that starch partially gelatinized or disrupted, although the process is chosen to limit the damage to the starch. In any embodiment a legume flour has a starch damage from 10% to about 50%, or from about 15% to about 50% from about 20% to about 50%, or about 20% to about 45%, or about 20% to about 40% or about 20% to about 35%, or about 25% to about 35%, wherein optionally the legume flour is a treated legume flour.

The de-flavoring process partially denatures protein in the legume flour or legume protein concentrate, although the process is chosen to limit the amount of protein denaturation. Different legume proteins have different denaturation enthalpies in their native state. So treated legume protein isolates have a different degree of denaturation. The de-flavoring processes as described and incorporated into this application reduce the degree of denaturation for the native protein no more than 4 J/g or between about 2 and 4 J/g. In any embodiment a treated pea protein concentrate has protein denaturation enthalpy from about 3.75 to about 5.0 J/g, or from about 4.0 to about 5.0, or to about 4.75 or to about 4.5, or to about 4.3. In any embodiment a treated fava bean protein concentrate having a protein denaturation enthalpy from 5.5 and 7.0 J/g, or from 5.5 to 6.5 J/g, or from 5.5 to 6.0 J/g.

Legume flours and legume protein concentrates comprise at least some starch, which in the embodiments described in this specification is an amylose containing starch. (It is not a waxy starch.) Legume starch has higher amylose content than other common food starches, like wheat starch, corn starch, rice starch, potato starch, and tapioca starch. Legume starch that is within a legume flour or legume protein concentrate described in this specification has amylose content between 30% and 40% (wt.%)

Batters and dry solids compositions comprising legume flours and legume protein concentrates as described in this specification may use any base legume. Useful legumes include, but are not limited to pea, fava bean, lentil, and chickpea. In some embodiments the base legume is pea. In some embodiments the base legume is fava bean. In some embodiments a legume flour and a legume protein concentrate are from a different base legume. In some embodiments a legume flour and legume protein concentrate are from the same base legume.

It is observed that the dry solids compositions described in this specification make batters having similar viscosity, coating pick-up, and batter stability to wheat flour batters at lower solids. For example commonly, wheat batters, comprise from 35% to 40% solids content (wt. %) whereas comparable batters are made using a mixture of legume flour and legume protein concentrate as described in this specification are used in an amount from about 15% to 30% by weight or from about 20% to about 30%, or from about 20% to about 28%, or from about 20% to about 26%. or from about 20% to about 24%.

The viscosity, batter pick-up, and stability against separation during storage for low solids content batters described in this specification is achieved without the use of gums or starch other than as provided by the legume protein concentrate and legume flour.

In addition to legume flour and legume protein concentrate the dry solids compositions and batter may further comprise salts, leavening agents (commonly chemical leavening agents), and other seasonings and flavorings.

The fry batters described in this specification may be used to coat any food commonly fried. Illustrative foods include chicken (tenders, nuggets, chicken parts), fish, shellfish, shrimp, crabs, beef, pork, other meats, vegetables (e.g. French fries, whether potato or sweet potato, tempura style fried foods vegetables, etc.), fried confections (cookies, cakes, etc.).

It is expected that the legume flours and concentrates will be used to at least partially replace a wheat flour or other starches or flours in batters or coating or mixtures thereof. If used as a partial replacement other starches and flours that may be used include com starch, waxy corn starch, tapioca starch, waxy tapioca starch, rice starch, waxy rice starch, potato starch, waxy potato starch, corn meal, rice flour, waxy rice flour, tapioca flour, waxy tapioca flour, and wheat flour. If other starches or flours are used in a batter or coating, they may be native, pregelatinized, partially pregelatinized, or modified such as by etherification, esterification, stabilization, inhibition, hydrolysis, dextrinization, oxidation, such modifications can be by physical, chemical, or enzymatic means.

In at least some embodiments the mixtures of legume flours and legume protein concentrates as described in this specification replace 100% of the other starches and flours such in the batter or coating. When used as a partial replacement it can be used to replace any amount of the other starch or flour, although preferably it will be used to replace at least about 50% of other starches flours (i.e. the mixture of legume flour and legume protein concentrate is at least 50% of the starches and flours used in the batter or coating) or is at least about 60% or at least about 70%, or at least about 80%, or at least about 90%, or at least about 91%, or at least about 92%, or at least about 93%, or at least about 94%, or at least about 95%, or at least about 96%, or at least about 97%, or at least about 98%, or at least about 99%.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions. labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus. for example, the terms “comprising,” “including,” “containing,” etc. shall be read expansively and without limitation. Additionally, the terms and expressions employed herein have been used as terms of description and not of limitation. and there is no intention in the use of such terms and expressions of excluding any equivalents of the features shown and described or portions thereof, but it is recognized that various modifications are possible within the scope of the claimed technology. Additionally. the phrase “consisting essentially of” will be understood to include those elements specifically recited and those additional elements that do not materially affect the basic and novel characteristics of the claimed technology. The phrase “consisting of” excludes any element not specified.

In addition. where features or aspects of the disclosure are described in terms of Markush groups. those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art. a range includes each individual member, and each separate value is incorporated into the specification as if it were individually recited herein.

The technology disclosed in this specification can be better understood with reference to the following aspects, which are not intended to limit the full scope of the disclosed technology
1. A dry solids coating composition comprising: a) a legume flour in an amount from about 30% or from about 35% to about 70% wt.% of the composition, or from about 30% to 60%, or from about 30% to about 50%, or from about 30% to about 45%, or 40% to about 70%, or to about 60%, or to about 50%; and a b) legume protein concentrate from about 30% or from about 35% to about 70% wt.% of the composition, or from about 30% to 60%, or from about 30% to about 50%, or from about 30% to about 45%, or 40% to about 70%, or to about 60%, or to about 50% wherein the composition is comprised a total amount of legume flour and the legume protein concentrate of from about 30% or from about 35% to about 70% wt.% of the composition, or from about 30% to 60%, or from about 30% to about 50%, or from about 30% to about 45%, or 40% to about 70%, or to about 60%, or to about 50%.
2. The dry solids coating composition of claim 1 wherein at least one of the legume flour and the legume protein concentrate is a treated legume flour or legume protein concentrate.
3. The dry solids coating composition of claim 1 or 2 wherein the legume flour is a treated legume flour and optionally, wherein the legume protein concentrate is a treated legume protein concentrate.
4. The dry solids coating composition of any one of claims 1 to 3 wherein the starch within the legume flour and legume protein concentrate has amylose content from about 30 to about 40% wt.%.
5. The dry solids composition of any one of claims 1 to 4 wherein the legume flour and the legume protein concentrate are selected from the group consisting of pea, fava bean, lentil, and chickpea.
6. The dry solids composition of any one of claims 1 to 5 wherein the legume flour and the legume protein concentrate are from the same type of legume, wherein optionally the legume is pea or fava bean.
7. The dry solids coating composition of any one of claims I to 6 wherein legume flour has a water holding capacity of at least about 1.4 (g/g), or at least about 2.0 or, at least about 2.15 or from about 2.15 to about 3.00 (g/g), or from about 2.15 to about 2.75, or to about 2.60, or to about 2.55, or to about 2.50, optionally wherein the legume flour is a treated legume flour.
8. The dry solids coating composition of any one of claims 1 to 7 wherein the legume flour has a starch damage from 10% to about 50%, or from about 15% to about 50% from about 20% to about 50%, or about 20% to about 45%, or about 20% to about 40% or about 20% to about 35%, or about 25% to about 35%, wherein optionally the legume flour is a treated legume flour.
9. The dry solids coating composition of any one of claims 1 to 8 wherein the legume protein concentrate has a protein content from at least about 40%, or at least about 45% or at least about 50% or at least about 55% to at most about 75% or at most about 70% or at most about 65%, optionally wherein the legume protein concentrate is treated.
10. The dry solids coating composition of any one of claims 1 to 9 wherein the legume protein concentrate is a treated pea protein having protein denaturation enthalpy from about 3.75 to about 5.0 J/g, or from about 4.0 to about 5.0, or to about 4.75 or to about 4.5, or to about 4.3.
11. The dry solids coating composition of any one of claims 1 to 10 wherein the legume protein concentrate is a treated fava bean protein concentrate having a protein denaturation enthalpy from 5.5 and 7.0 J/g, or from 5.5 to 6.5 J/g, or from 5.5 to 6.0 J/g.
12. The dry solids coating composition of any one of claims 1 to 11 wherein the composition does not comprise a gum or starch other than as provided by the legume protein concentrate and legume flour.
13. A batter comprising: a dry solids composition as described in any one of claims 1 to 11 and water in an amount from about 15% or 30% by weight or from about 20% to about 30%, or from about 20% to about 28%, or from about 20% to about 26%, or from about 20% to about 24%.
14. A food comprising a batter as described in claim 12.
15. Use of a batter as described in claim 12 as a coating for a food.

The technology disclose in this specification can be better understood with reference to the following examples, which are provided for illustrative purpose and are not intended to limit the full scope of the technology disclose in this specification.

### EXAMPLE 1—PROCESSES FOR MAKING TREATED LEGUME FLOUR

Treated legume flours were made using a two-stage turbo reactor comprising thermal cooking reactor and drying reactor. Both stages of the reactor were jacketed hollow-tube reactors with inlets for receiving a liquid or a gas. The jacket heated the inner surface of the hollow-tube reactor. During processing raw legume flour (moisture content about 10%) was fed into the cooking reactor along with steam and water (from separate inlets) to form a high moisture flour. The flour passed through the reactor and was then dried in the drying reactor, which dried the legume flour using heat and warmed air.

Treated legume flours were made from pea flour base, lentil flour base, and fava bean flour base. The base material was obtained by milling split pea or fava bean to obtain the corresponding flour. Various processing conditions used to make treated pea flours are reported in Table 1. The process variables described were applied in the cooking reactor. For all batches water temperature was 80° C. All legume flours used were full protein, having protein content essentially the same as the base legume.

TABLE 1
Cook Reactor Process Conditions For Pea Flour

| | | Cooking | Cooking | | | | Steam |
|---|---|---|---|---|---|---|---|
| | Feed | reactor | reactor | Water | Feed Rate | Steam | rate to |
| | Rate | temperature | speed | Rate | to Water | Rate | feed rate |
| Batch | (kg/hr) | (wall) (° C.) | (RPM) | (L/hr) | Rate Ratio | (L/hr) | ratio |
| P1015 | 3300 | 180 | 400 | 800 | 4.1:1 | 300 | 11:1 |
| P1120 | 4000 | 180 | 400 | 800 | 5:1 | 300 | 13.3:1 |
| P1220 | 5400 | 180 | 500 | 600 | 9:1 | 300 | 18:1 |
| P1320 | 3300 | 180 | 500 | 800 | 4.1:1 | 300 | 11:1 |
| P1250 | 5400 | 180 | 500 | 900 | 6:1 | 300 | 18:1 |
| P1130 | 4000 | 180 | 500 | 900 | 4.4:1 | 300 | 13.3:1 |

Treated fava bean flours were made using various process conditions reported in Table 2. The process variables described were applied in the cooking reactor. For all batches water temperature was 80° C.

TABLE 2
Cook Reactor Process Conditions For Fava Bean Flour

| | | Cooking | Cooking | | | | |
|---|---|---|---|---|---|---|---|
| | Feed | reactor | reactor | Water | Feed Rate | Steam | Feed rate |
| | Rate | temperature | speed | Rate | to Water | Rate | to steam |
| Batch | (kg/hr) | (wall) (° C.) | (RPM) | (L/hr) | Rate Ratio | (L/hr) | rate ratio |
| F1215 | 5400 | 180 | 400 | 600 | 9:1 | 300 | 18:1 |
| F1300 | 5400 | 180 | 500 | 600 | 9:1 | 300 | 18:1 |
| F1400 | 5400 | 180 | 500 | 900 | 6:1 | 300 | 18:1 |
| F1000 | 5400 | 200 | 500 | 900 | 6:1 | 300 | 18:1 |
| F1100 | 5400 | 200 | 500 | 600 | 9:1 | 300 | 18:1 |
| F1200 | 5400 | 200 | 400 | 600 | 9:1 | 300 | 18:1 |
| F1145 | 5400 | 200 | 400 | 900 | 6:1 | 300 | 18:1 |

Treated lentil flours were made using various process conditions reported in Table 3. The process variables described were applied in the cooking reactor. For all batches water temperature was 80° C.

TABLE 3
Cook Reactor Process Conditions For Lentil Flour

| | | Cooking | Cooking | | | | |
|---|---|---|---|---|---|---|---|
| | Feed | reactor | reactor | Water | Feed Rate | Steam | Feed rate |
| | Rate | temperature | speed | Rate | to Water | Rate | to steam |
| Batch | (kg/hr) | (wall) (° C.) | (RPM) | (L/hr) | Rate Ratio | (L/hr) | rate ratio |
| L0930 | 5400 | 180 | 400 | 600 | 9:1 | 300 | 18:1 |
| L1345 | 5400 | 200 | 500 | 900 | 6:1 | 300 | 18:1 |

All samples of treated pea flour and treated fava bean flour were dried in the drying reactor under the same conditions, which are listed in Table 4.

TABLE 4
Drying Reactor Process Conditions

| Dryer | Dryer Oil Inlet | Air | Air Fan |
|---|---|---|---|
| speed | Temperature | Temperature | Speed |
| (RPM) | (° C.) | (° C.) | (%) |
| 400 | 180 | 150 | 60 |

### EXAMPLE 2—CHARACTERIZATION OF STARCH DAMAGE LEVEL OF PULSE FLOUR

Treated legume flours made as described in Example 1. Treated and un-treated legume flours were evaluated damage treated relative to untreated flour and for effect on water holding capacity.

### EXAMPLE 2A—STARCH DAMAGE

Damage to treated flour was evaluated using Differential Scanning calorimetry (DSC) analysis. Damage to both the starch and to the protein was evaluated. Reported starch damage values are gelatinization enthalpy peak for the starch from a treated legume flour and as a percent change between gelatinization enthalpy peak of the starch from the treated flour and an untreated starch of the same time, called “percent damage.” Note that gelatinization enthalpy peaks of starch are known, essentially consistent for a type of starch, and generally different for different types of starch. Percent damage to starch, therefore, can be calculated with reference to reported gelatinization enthalpy peaks or with reference to commercially available pea flours.

DSC process used for measuring starch damage follows. Legume flour, sample for DSC was prepared at 33% w/w in deionized water. Sixty milligrams of prepared sample were loaded into DSC high volume pan. DSC was performed from 20 to 140° C. at a heating rate of 10° C./min using a high-volume pan with deionized water as the reference using a TA Q2000 DSC instrument (TA Instruments). The ratio of starch enthalpy peak of processed pulse flour to that of an untreated pulse flour represents the amount ratio of undamaged starch. The starch damage level was then calculated by subtracting the ratio from one hundred percent. Although measurements were done on flour (including starch and protein), the enthalpies reported in Table 5 correlate to starch gelatinization (instead of protein denaturation) because the high sample solid content and fast temperature ramp so it was too fast for protein to react to the temperature change. Together with the low protein content in flour and low solids content overall, the enthalpy change is essentially all from starch gelatinization.

Starch damage of treated and untreated pea flour is reported in Table 5.

TABLE 5
Percent Starch Damage of Pea Starch in Pea Flour

| Batch | Starch damage level (%) |
|---|---|
| Pea Flour | 0 |
| (untreated) | |
| P1015 | 49.1 |
| P1120 | 45.7 |
| P1220 | 13.1 |
| P1320 | 65.3 |
| P1250 | 40.4 |
| P1050 | 33.0 |

The starch damage of treated and untreated fava bean protein is reported in Table 6

TABLE 6
Percent Starch Damage of Fava Starch in Fava Bean Flour

| Batch | Percent Starch Damage |
|---|---|
| Fava Bean Flour | 0.00 |
| (untreated) | |
| F1215 | 26.09 |
| F1300 | 32.61 |
| F1400 | 36.96 |
| F1000 | 39.13 |
| F1100 | 26.09 |
| F1200 | 26.09 |
| F1145 | 36.96 |

### EXAMPLE 2B—WATER HOLDING CAPACITY

Water holding capacity was determined for treated pea flours, treated fava bean flours and treated lentil flours. Water holding capacity was measured as follows: 1.0 g (dry basis) of the flour was added to a 50 mL tube. 10 mL of DI water was added to the tube and vortexed at high speed for 1-2 minutes, ensuring that there were no lumps or aggregates in the solution. Sample was left to sit at room temperature for 30 minutes. It was then centrifuged at 3000×g for 20 minutes at room temperature. The supernatant was then decanted. The weight of the precipitate was measured and the water holding capacity was calculated as the increase in weight (wet/dry). Results are reported in Table 7 as a ratio (g/g).

TABLE 7
Water Holding Capacity of Legume
Flours and Treated Legume Flours

| | Water holding |
|---|---|
| Legume Flour | capacity (g/g) |
| Pea Flour (untreated) | 1.24 |
| Treated Pea Flour (P1050) | 2.4 |
| Fava bean flour (untreated) | 2.10 |
| Treated Fava Bean Flour | 2.26 |
| (F1145) | |
| Treated Fava Bean Flour | 2.19 |
| (F1200) | |
| Lentil flour (untreated) | 2.10 |
| Treated Lentil Flour (L0930) | 2.29 |
| Treated Lentil Flour (L1345) | 2.50 |

As seen samples generally (excepting pea) treated legume flours have water holding capacity like the untreated flour showing that legume flours can be treated to have less intense flavor compared to the untreated flours retaining similar functional performance to the untreated flour.

Considering all treated legume flours, all have water holding capacity between about 2.1 and 2.5 (g/g). Relative to untreated pea flours this shows improvement. But it also shows that the de-flavoring process can be used to standardize the water holding of treated legume flours across legume type.

### EXAMPLE 3—PROCESSES FOR MAKING TREATED LEGUME PROTEIN CONCENTRATE

Treated legume protein concentrates were made from a base pea protein concentrate having about 55% protein content (wt. %) using the methods described in this examples. The batches listed in this Example use pea protein concentrates were obtained using air classification of base pea flours, that were obtained by a dry milling processes. The classified base pea protein concentrate was then treated using a two-stage turbo reactor comprising thermal cooking reactor and drying reactor. Both stages of the reactor were jacketed hollow-tube reactors with inlets for receiving a liquid or a gas. The jacket heated the inner surface of the hollow-tube reactor. During processing raw pea flour or raw pea protein concentrate (moisture content about 10%) was fed into the cooking reactor along with steam and water (from separate inlets) to form a high moisture protein concentrate. The pea flour and pea protein concentrate passed through the reactor and were then dried in the drying reactor, which dried the pea flour or the pea protein concentrate using heat and warmed air.

Following de-flavoring the treated pea protein concentrate is milled using a Hosokawa Air Classification Mill to break up agglomerates and control for particle size. The air classification mill has three separated mechanism for adjusting particle size, air flow speed, rotor speed, and separator speed. For all trials, air flow speed and rotor speed were fixed, but separator speed was varied to obtain material having different particle size. Generally, powder milled at faster separator speed is finer.

Various treated pea protein concentrates were made by treating base pea protein concentrates using the processing conditions described in Table 8. Mill separator speed refers to the separate speed of the Hosokawa Air Classifying Mill and is applied after de-flavoring treatment. Feed rate refers to feed rate of the base pea protein concentrate. Water rate and steam rate refer to the rate of water or steam flow into the cooking reactor.

TABLE 8
Cook Reactor Processing Conditions for Treated Pea Protein Concentrate

| | | Feed Rate | | | | Feed | | Feed |
|---|---|---|---|---|---|---|---|---|
| | Mill | or base pea | Cooking | Cooking | | Rate to | | rate to |
| | Separator | protein | reactor | reactor | Water | Water | Steam | steam |
| | Speed | concentrates | temperature | speed | Rate | Rate | Rate | rate |
| Batch | (RPM) | (kg/hr) | (wall) (° C.) | (RPM) | (L/hr) | Ratio | (L/hr) | ratio |
| PC1320 | 1200 | 3300 | 180 | 400 | 800 | 4.1:1 | 300 | 11:1 |
| PC1230 | 1250 | 3300 | 180 | 500 | 600 | 5.5:1 | 300 | 11:1 |
| PC1140 | 1300 | 3300 | 160 | 500 | 600 | 5.5:1 | 300 | 11:1 |
| PC1210 | 1150 | 3300 | 160 | 500 | 800 | 5.5:1 | 300 | 11:1 |
| PC1100 | 1200 | 3300 | 180 | 400 | 600 | 5.5:1 | 300 | 11:1 |
| PC0935 | 1300 | 3300 | 160 | 400 | 600 | 5.5:1 | 300 | 11:1 |
| PC1020 | 1250 | 3300 | 160 | 400 | 800 | 4.1:1 | 300 | 11:1 |
| PC1125 | 1050 | 3300 | 160 | 500 | 800 | 4.1:1 | 300 | 11:1 |
| PC1000 | 1050 | 3300 | 180 | 400 | 800 | 4.1:1 | 300 | 11:1 |

All samples of treated pea protein concentrates were dried in the drying reactor under the same conditions, which are listed in Table 9.

TABLE 9
Drying Reactor Process Conditions

| Dryer | Dryer Oil Inlet | Air | Air Fan |
|---|---|---|---|
| speed | Temperature | Temperature | Speed |
| (RPM) | (° C.) | (° C.) | (%) |
| 400 rpm | 180 | 150 | 60 |

### EXAMPLE 4—CHARACTERIZATION OF PERCENT CHANGE OF DENATURATION ENTHALPY OF PULSE PROTEIN CONCENTRATE

Additional samples were made using the process of PC1000. The samples were measured for percent change in denaturation enthalpy to assess the level of protein damage. Denaturation enthalpy was measured using differential scanning calorimetry (“DSC”). Measurements were made as follows: samples were prepared at 5% (w/v) protein in water in a high-volume stainless DSC pan. A reference pan was prepared with equal weight of water only. The sample and reference pans were heated at 2° C. per minute from 20° to 100° C.

Denaturation enthalpy of treated pea protein concentrates and percent change in denaturation enthalpy between a base pea protein concentrate and the treated pea protein concentrates is reported in Table 10.

TABLE 10
Denaturation Enthalpy of Treated Pea Protein Concentrates

| | Denaturation | Percent Change |
|---|---|---|
| Sample | Enthalpy (J/g) | Denaturation Enthalpy (%) |
| Base pea Protein | 5.19 | N/A |
| Concentrate | | |
| PC0945 | 4.22 | 18.7 |
| PC1050 | 4.16 | 19.9 |
| PC1305 | 4.15 | 20.1 |
| PC1415 | 4.00 | 22.9 |
| PC1156 | 4.15 | 20.0 |

### EXAMPLE 5—WATER SOLUBILITY OF TREATED PEA PROTEIN CONCENTRATES

Treated pea protein concentrates were evaluated for percent solubility of protein. Percent protein solubility of a treated pea protein concentrate was determined using a modified method of Morr et al. (J. Food Science 50(1985) 1715-et seq.) and Karaca et al (Food Res. Int'l 44 (2011) pp. 2742-2750). Protein solutions were prepared by dispersing 1% w/v of protein in buffer with pH adjustment to 7 with either 0.1 M NaOH or 0.1 M HCl as needed. Following establishing desired pH, protein concentrate was mixed with solution (solution into protein) by vortexing for 30 sec for 1 hour followed by centrifuging at 4000×g for 10 min at room temperature. The nitrogen content of the supernatant was determined using LECO protein analyzer (LECO, TruMac® N). Percent protein solubility was calculated by dividing the nitrogen content of the supematant by the total nitrogen in the sample (×100%).

Percent soluble protein in a treated pea protein concentrate is reported in Table 11.

TABLE 11
Percent Soluble Protein in Treated Pea Protein Concentrate

| Batch | % Soluble Protein (w/w) |
|---|---|
| Base pea protein concentrate | about 80% |
| PC0945 | 53 |
| PC1050 | 54 |
| PC1305 | 52 |
| PC1415 | N/A |
| PC1156 | 52 |

### EXAMPLE 6—USE OF TREATED FLOUR

Legume flours and legume protein concentrates were added evaluated in fry batters. Batters were made according to the formula described in Table 12. Treated fava bean protein and treated pea protein were used to make separate batters.

TABLE 12
Batter Using Treated Pulse Flour

| Ingredion | Wt. % |
|---|---|
| Treated pulse flour (10% | 46.50 |
| protein) | |
| Treated pulse protein | 46.50 |
| concentrate (60% protein) | |
| Salt | 6.00 |
| SAPP # 28 (Sodium Acid | 0.50 |
| Pyrophosphate) | |
| Baking Soda | 0.50 |
| Total | 100.00 |

Four batters were made using the above formula. Two were based on fava bean materials, using one of a standard fava bean flour or a treated fava bean flour, and using treated fava bean protein concentrate. The other two were based on pea, using one of a standard pea flour or a treated pea flour, and using treated pea protein concentrate.

Batters were made by hydrating all ingredients to make batter having solids content in water of 28%, 26%. 24%, or 22% (wt.% solids) (or 72%, 74%, 76%, or 78% wt.% water). Ingredients in water were mixed with an immersion blender until homogenous, about 10 minutes. Batter was used to coat chicken nuggets. Chicken breast was cut to form nuggets (10 to 13 g per piece). Nuggets were pre-dusted with a dry mix of 75% pea flour and 25% potato starch to form a relatively even coat. Excess pre-dust was shaken off. Dusted nuggets were covered with batter and excess batter was shaken off. Nuggets were par-fried at 375° F. (about 191° C.) for 45-50 seconds and then frozen (−18° C.) for at least 24 hours. Frozen nuggets were fried to final cook at from 350° F. to 360° F. (about 177° to about 182° C.) for about 4 minutes or until the chicken nugget reaches an internal temperature of 165° F. (about 74° C.).

Batters and chicken nuggets coated with legume flour/legume protein concentrate batters (as described in this Example) were compared to batters and chicken nuggets coated with a wheat flour-based batter at solids content between 35% and 40% wt. %. It was observed that chicken nuggets having the legume flour/legume protein concentrate batters had similar viscosity, batter pick-up, and adhesion to wheat batters needed between 35% and 40% solids.

Additionally, it was observed that batters made from treated legume flour and treated legume protein concentrates could be refrigerated (about 4° C.) for at least 72 hours without separation. Batters having more than 22% solids content did not separate without use of common suspending agents such as gums or additional starch.

Note that batters of the type described in this specification are commonly used within 24-hours of being mixed. It is expected that batters at 22% solids usage would be acceptable for most use cases.

Par-fried foods made as described in this example were evaluated after final cooking (reconstitution) from frozen using other cooking methods.

Final cooking using conventional oven was done using 75 grams of frozen coated product heated using a conventional oven (without air convection) at a temperature between 375° and 425° F. (about 190° to about 218° C.) for 15-30-minute bake time. Final products were observed to have a crispy and crunchy coating that was not soggy to the touch. Some dark spots were observed (non-homogenous color), but still had golden in color.

Final cooking using air frying was done using 75 grams of frozen coated product heated using a standard air frier at a temperature between 350° and 400° F. (about 176° to 206°) for 15-30-minutes. Coating was observed to be dry and crispy but has a slight sandy/gritty texture. Some dark spots observed (non-homogenous color), but still golden in color.

What is claimed is:

1. A dry solids coating composition comprising:
a) a legume flour in an amount from about 30% to about 70%,; and a
b) legume protein concentrate from about 30% to about 70%,
wherein the composition comprises a mixture of legume flour and the legume protein concentrate in an amount from about 30% to about 70% wt.%.

2. The dry solids coating composition of claim 1 wherein at least one of the legume flour and the legume protein concentrate is a treated legume flour or legume protein concentrate.

3. The dry solids coating composition of claim 1 wherein the legume flour is a treated legume flour and optionally, wherein the legume protein concentrate is a treated legume protein concentrate.

4. The dry solids coating composition of claim 1 wherein the starch within the legume flour and legume protein concentrate has amylose content from about 30 to about 40% wt.%.

5. The dry solids composition of claim 1 wherein the legume flour and the legume protein concentrate are selected from the group consisting of pea, fava bean, lentil, and chickpea.

6. The dry solids composition of claim 1 wherein the legume flour and the legume protein concentrate are from the same type of legume, wherein optionally the legume is pea or fava bean.

7. The dry solids coating composition of claim 1 wherein legume flour has a water holding capacity of from about 2.15 to about 3.00 (g/g).

8. The dry solids coating composition of claim 1 wherein the legume flour has a starch damage from 10% to about 50%.

9. The dry solids coating composition of wherein the legume protein concentrate has a protein content from about 40%, to about 75%.

10. The dry solids coating composition of claim 1 wherein the legume protein concentrate is a treated pea protein having protein denaturation enthalpy from about 3.75 to about 5.0 J/g.

11. The dry solids coating composition of claim 1 wherein the legume protein concentrate is a treated fava bean protein concentrate having a protein denaturation enthalpy from 5.5 and 7.0 J/g.

12. The dry solids coating composition of claim 1 wherein the composition does not comprise a gum or starch other than as provided by the legume protein concentrate and legume flour.

13. A batter comprising: a dry solids composition as described in claim 1 and water in an amount from about 15% or 30% by weight.

14. A food comprising a batter as described in claim 13.

15. (canceled)
